(19) United States
(12) Patent Application Publication
(10) Pub. No.: US 2016/0096461 A1
(43) Pub. Date: Apr. 7, 2016

(54) Vehicle seat

(71) Applicant: GORDON MURRAY DESIGN LIMITED, Shalford Surrey (GB)

(72) Inventor: Frank Coppuck, Hook (GB)

(73) Assignee: Gordon Murray Design Limited, Shalford (GB)

(21) Appl. No.: 14/892,504

(22) PCT Filed: Jun. 26, 2014
(86) PCT No.: PCT/EP2014/063599

§ 371 Date: Nov. 19, 2015

(30) Foreign Application Priority Data
Jun. 28, 2013 (GB) 1311699.1

(51) Int. Cl. B60N 2/68; B60N 2/48; B60N 2/20

(52) U.S. Cl. CPC B60N 2/686; B60N 2/20; B60N 2/4808

(57) ABSTRACT

A vehicle seat (10) comprises a base unit (12) and an upright seat back (14), the base unit (12) being moulded composite materials with optimised fibre orientations and metallic fixing points for attachment to the vehicle and at least two laterally-spaced upstanding arms (46), the seat back (14) being of a moulded composite material with optimised uni-directional fibre orientations and being attached to each upstanding arm (46) via a connection that is distributed along the vertical direction. This vertical distribution can be achieved by providing a plurality of mechanical attachments (48) between the two parts, with the attachments (48) spaced apart in the vertical direction.

### FIELD OF THE INVENTION

The present invention relates to a seat for a vehicle.

### BACKGROUND ART

Some form of seating is essential for the driver and passengers in a vehicle, to support them in comfort during the journey and restrain them in the event of a collision. This is typically a greater challenge in the design of small urban vehicles, as these suffer from a lack of internal space vertically and horizontally around the occupants. Thus, taller drivers and rear-seat passengers may suffer from a lack of adequate leg and/or headroom to be comfortable.

In addition, conventional vehicle seats are generally between 30 to 70 Kg. Modern vehicles have a requirement to keep weight to a minimum. Current pressed steel seat designs are driven by regulations relating to crash testing, whiplash, curb strike etc and are thus not generally seen as an area likely to yield useful weight savings.

A wide range of lightweight seats are available for motorsport applications, but are characterised by much lower levels of adjustability, comfort and accessibility so are regarded as unsuitable for use in most types of road vehicles (including urban vehicles). In addition, such seats are typically installed and used in conjunction with other safety measures such as harnesses, roll cages, helmets and the like, and are thus subject to different considerations with regard to impact testing (etc).

### SUMMARY OF THE INVENTION

A seat that offered a combination of light weight, minimal material consumption and use of recycled and recyclable materials, while also being designed to pass crash testing requirements, would be highly desirable.

The present invention therefore provides a vehicle seat, comprising a base unit and an upright seat back, the base unit being at least partly metallic and comprising fixing points for attachment to the vehicle and at least two laterally-spaced upstanding arms, the seat back being of a moulded composite material and being attached to each upstanding arm via a connection that is distributed along the vertical direction. This vertical distribution can be achieved by providing a plurality of mechanical attachments between the two parts, with the attachments spaced apart in the vertical direction. Alternatively, an adhesive bond with an elongate extent in the vertical direction can be used, or the upstanding arms can be embedded in the material of the seat back.

The base unit can be partly made up of composite moulded materials in addition to metallic elements. The composite moulded elements can provide reinforced sections, ideally defined by multiple layers of moulded composite material which may have an optimised fibre orientation in order to provide the seat with the necessary level of rigidity and crashworthiness. An adjustable mechanism can also be provided, thereby to vary the angle between the upstanding arms and a remaining part of the base unit and allowing the rake of the seat to be adjusted. The adjustable mechanism can comprise a spindle around which a part rotates, and which extends to engage with the seat back; in doing so it will further reinforce the connection between the seat back and the base unit. Most seats will also have a seat base or squab, attached to the base unit. The seat base can also be of moulded composite materials, and can be fixedly attached to the base unit.

The base unit can also include sliding adjusters or mounting points for such adjusters, to allow the fore/aft position of the upstanding arms relative to the fixing points to be adjusted, thus permitting the seat to be adjusted back and forth.

The upstanding arms are preferably disposed adjacent to either side of the seat back. The seat back can comprise reinforced sections defined by multiple layers of moulded composite material. These may have an optimised fibre orientation in order to provide it with a necessary level of rigidity and crashworthiness. The moulded geometry reinforced sections can define at least one hollow space, as such structures offer a high rigidity and improved mechanical performance.

Such a hollow space can define a tube having an opening at the upper edge of the seat, with the seat further comprising a headrest having at least one downwardly-extending prong, the prong and the tube being slidably engageable thereby to retain the headrest above the seat in a vertically adjustable manner.

The composite material will usually comprise a fibre reinforcement within a matrix, although other forms of composite material are possible. This offers the possibility of optimising the fibre alignment so as to tailor the seat's mechanical properties. In the seat back, it is advantageous to include an area of unidirectional fibre reinforcement aligned in an upwards direction in the seat back, ideally located on the two outer vertical edge regions of the seat back which can increase in width towards a top edge of the seat back, preferably meeting at a central point of the top edge of the seat back. It is also advantageous to include an area of unidirectional fibre reinforcement aligned in a lateral direction along a top edge of the seat back, and an area of quasi-isotropic laminated fibres covering at least the vertically-distributed connection with the upstanding arms. An area of bi-directional reinforcement, aligned in each of the two directions that are at substantially 45° to the upright and lateral directions can also be provided.

In the base unit, a seat base can also be of a fibre-reinforced composite material. This can advantageously include an area of unidirectional fibre reinforcement in an outwards lateral direction in the sides of the seat base, an area of quasi-isotropic laminated fibres around a seat mounting area, and an area of bi-directional reinforcement, aligned in each of the two directions that are at substantially 45° to the longitudinal and lateral directions.

The present invention also relates to a vehicle comprising at least one seat according to any one of the preceding claims.

As a result of the above, it is practical and viable to produce an automotive seat seat that is usable day-to-day and which is of composite materials. Such materials allow a number of advantages, such as reducing the section thickness of the base which in turn allows the occupant to be packaged lower, giving a lower roof line and a lower vehicle centre of gravity. The lower centre of gravity allows improvements in vehicle handling and the static stability of the vehicle (from a rollover perspective), and the lowering of the roof line yields a reduction in the aerodynamic drag of the vehicle, thus reducing the vehicle running emissions.

### BRIEF DESCRIPTION OF THE DRAWINGS

An embodiment of the present invention will now be described by way of example, with reference to the accompanying figures in which;

FIG. 1 shows a front side view of a first embodiment of the seat;

FIG. 2 shows a rear side view of the seat of FIG. 1;

FIG. 3 shows a rear side view of the seat of FIG. 1 with some trim panels removed

FIG. 4 shows a side view of the seat of FIG. 1 with some trim panels removed;

FIG. 5 shows an enlarged view of the connection between the base unit and the seat back of the seat of FIG. 1, with some trim panels removed;

FIG. 6 shows the same view as FIG. 5 but with the trim panels in place;

FIG. 7 shows a rear side view of a second embodiment of the present invention;

FIG. 8 shows a rear view of a third embodiment of the present invention; and

FIG. 9 shows the preferred fibre orientations for the seat.

### DETAILED DESCRIPTION OF THE EMBODIMENTS

In this application, references to directions such as fore/aft, vertical, inwardly, lateral and the like are all intended to be interpreted relative to the seat itself. As people sit in a defined position with their legs projecting in a forward direction, no ambiguity therefore arises. Seats are usually installed in a vehicle facing forward, so the same directional indications will usually apply relative to the vehicle as well. However, it is permissible to mount seats in a rearward facing orientation so it is possible that the directions will be reversed relative to the vehicle in question.

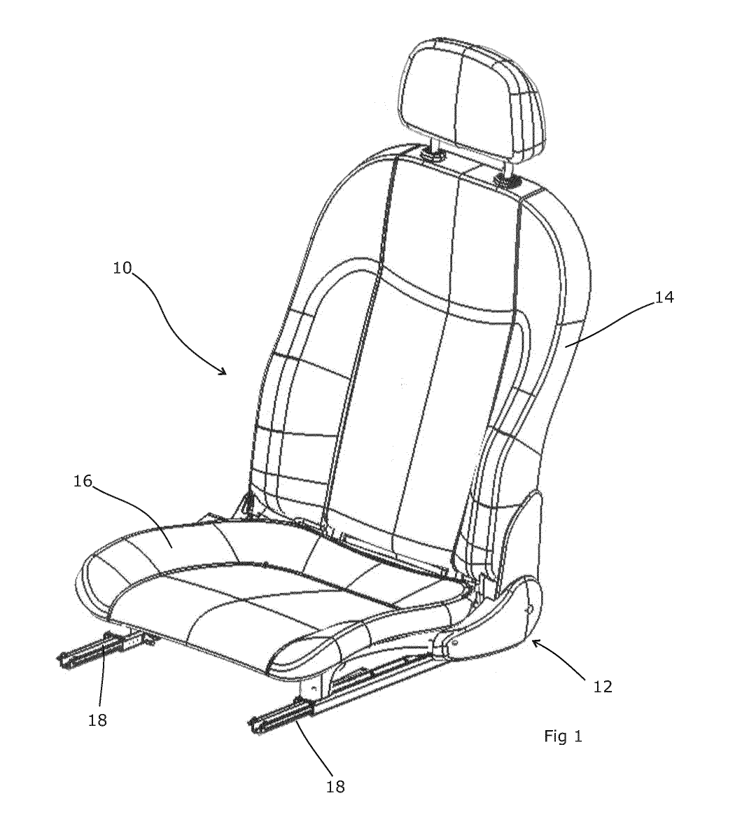

Referring to FIG. 1, a vehicle seat 10 consists of three main sections, being a base unit 12, a seat back 14 and a seat base 16. The base unit 12 includes a pair of fore & aft adjustable runners 18 of conventional design, via which it is attachable to a suitably robust section of the floor of a vehicle. The seat back and the seat base are moulded composite panels employing recycled and recyclable materials such as household and industrial waste products (refuse, for example) thermoformed to a shape suited to receiving a typical human form. Both are attached to the base unit 12 as will be described.

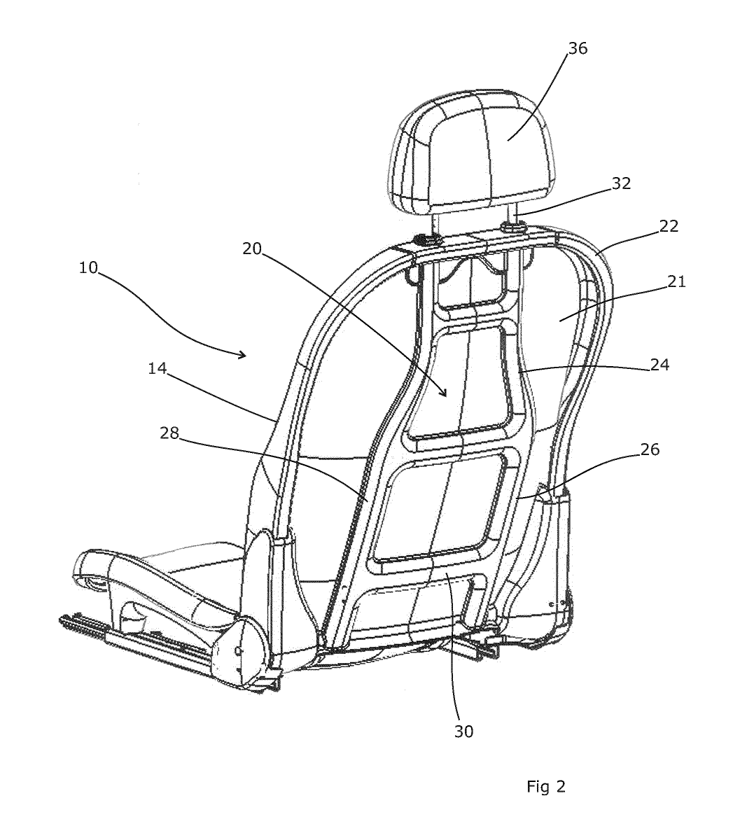

FIG. 2 shows the seat back 14 more clearly. A single sheet which includes hybrid composite materials 20 defines most of the seat back form. At least the upper seat wings 21 have an optimised uni-directional fibre placement ensuring stiffness and strength in the direction of the principal in-service loads. The edge 22 has a transverse rim profile designed to allow easier fitting of foams and trims, and reduce weight while maintaining rigidity. An engineered reinforcement structure 24 on the rear of the seat back 14 provides added geometric stiffness. The position, size and location of the reinforcement structure 24 are optimised to assist in comfort, safety during a crash, and weight reduction.

This geometric reinforcement 24 is located along the central spine of the seat back 14 in order to provide support between the edge regions on either side. It takes the form of a ladder-shaped moulding, i.e. two upright reinforcements 26, 28 with horizontal cross-members 30 running between tem at intervals.

The two uprights extend from the lower edge of the seat back 14 to its upper edge, at which point they narrow together in order to align with two vertical prongs 32, 34 of a headrest 36. The uprights (or at least their upper sections) are hollow and thus able to accept the prongs 32, 34 and retain the headrest 36 in place.

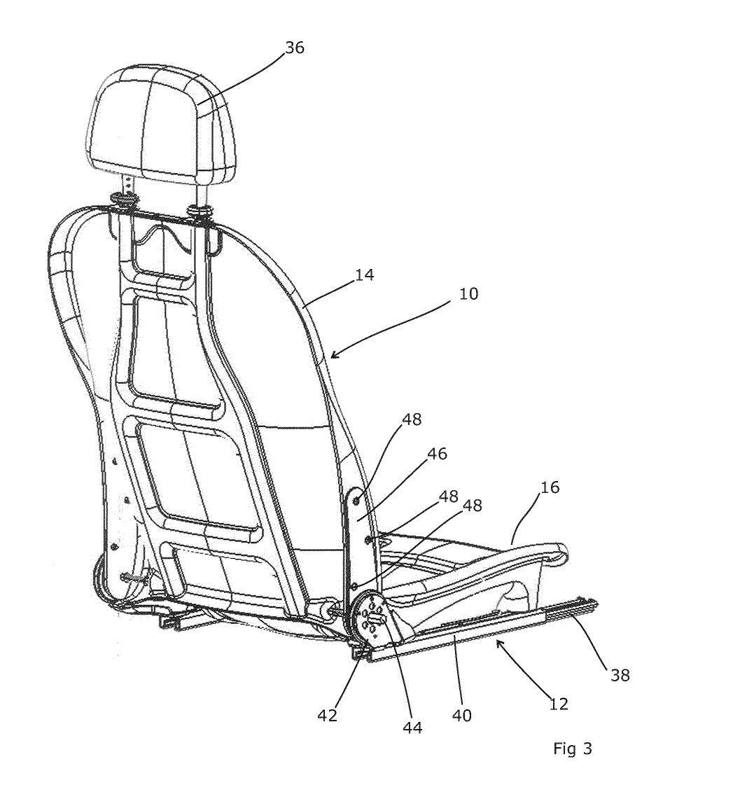

FIG. 3 shows the base unit 12 in more detail. The slidable runners mentioned previously comprise a pair of steel fixed runners 38 that are attachable to the vehicle floor, on which slide a pair of seat runners 40 to which the remainder of the base unit is attached. This consists of a boss 42 on either side of the base unit 12, extending upwardly and slightly rearwardly. A spindle 44 passes through the boss 42 and through a rotation axis of an upstanding arm 46. This is located just inboard of the boss 42 and is rotatable about the spindle relative to the boss 42. A locking mechanism is provided (not visible in FIG. 2) to hold the two parts in a chosen relative position and to release (thereby allowing rotation) when desired. A like upstanding arm is provided on the opposing side.

The upstanding arms are attached to the outer edge regions of the seat back 14, in this embodiment. The attachment is via several fixings 48 (such as bolts with suitable nuts and washers), in this case three, that are distributed over the vertical extent of the upstanding arm. Other suitable fixings include a length of adhesive extending over the arm. This holds the seat back 14 in place, with rotation of the upstanding arms 46 about the spindle 44 allowing adjustment of the seat back angle. The use of a fixing or fixings spread over the extent of the upstanding arm means that the best advantage can be made of both materials. The steel of the base unit provides a hard and rigid material for attaching to the vehicle and controlling the seat back angle. The composite materials make up the major part of the seat, thereby taking advantage of their mechanical performance, ease of fabrication and light weight properties. However, the extended fixing between them allows forces to be transferred over a distributed length rather than via a point load to which composite materials are unsuited. In this way, a lightweight adjustable seat can be provided. Typically, composite moulded seats are fixed in a specific shape, which may be acceptable for specialist applications such as motorsport but unsuited to more general use where they may be used by a variety of people of different sizes.

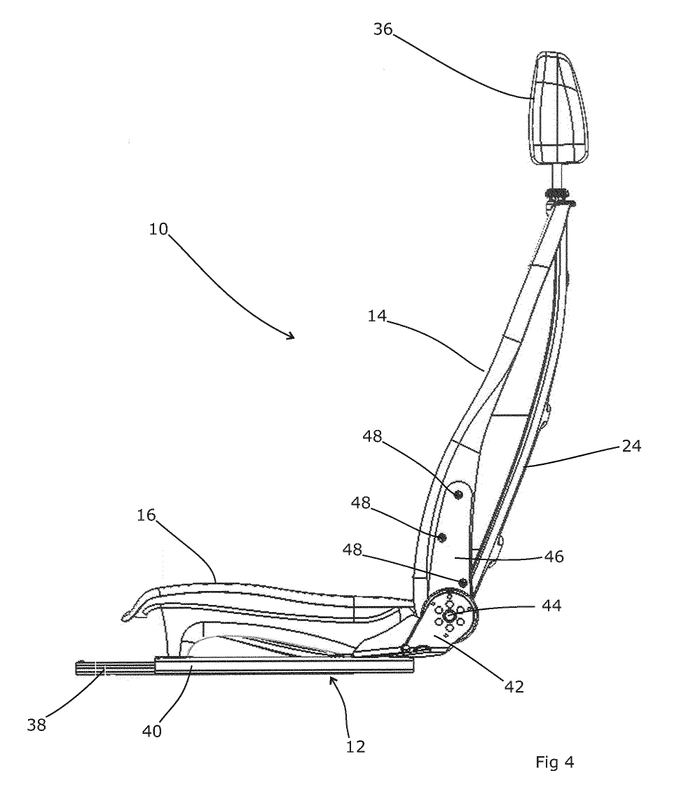

FIG. 4 shows a side view of the seat, from which the moulded contours of the seat back 14 can be seen. In particular, the seat back has a generally planar section bounded by the reinforcement structure 24, on either side of which it curves forward to provide lateral support to the driver or passenger seated in it.

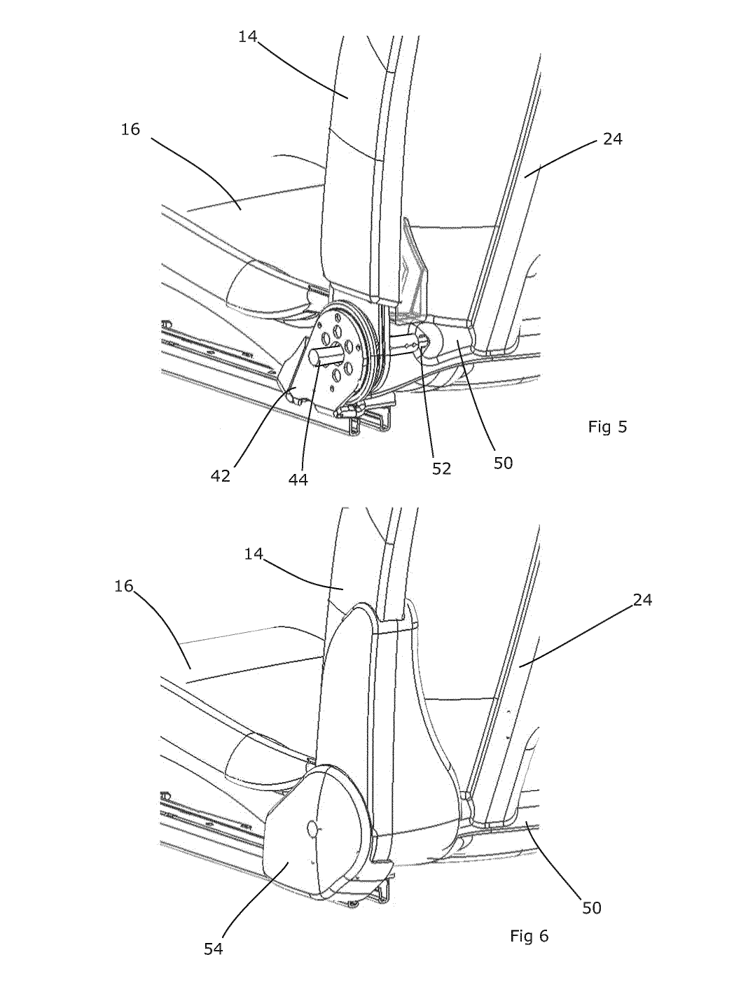

FIGS. 5 and 6 shows the base of the seat back 14 in more detail. It can be seen that the reinforcement structure 24 extends to the lower part of the seat back 14 and includes a further cross-member 50. In this example, the further cross-member 50 extends beyond the lateral width of the upright reinforcements 26, 28. It ends with an open aperture 52 able to receive an end of the spindle 44, thereby holding the spindle securely in place. FIG. 6 then shows the trim panel 54 in place to protect the mechanism from damage and the driver/passenger from the mechanism.

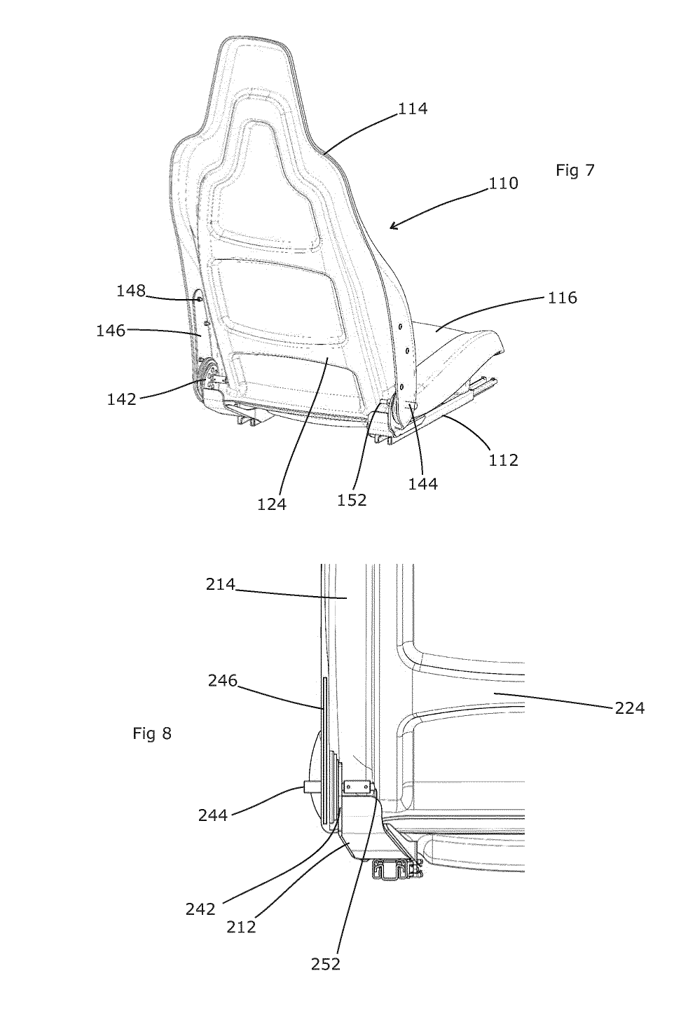

FIG. 7 illustrates a second embodiment of seat 110, again having a base unit 112 supporting a seat back 114 and a seat squab 116. This is largely the same as the first embodiment, differing in that the upstanding arms 146 are attached to the inner face regions of the seat back 114 instead of the outer faces. Thus, to assist with this, the boss 142 is provided on the base unit 112 within the outer extent of the seat back. The spindle 144 thus passes through, in sequence from the outside in, a rear side face of the seat back 114, the upstanding arm 146, and the boss 142, before engaging in the open aperture 152 of the reinforcement structure 124.

In addition, the second embodiment differs from the first in that an alternative shape is adopted for the seat back 114, in which an integral headrest is provided. Many such variations can be made to the specific shape of seat, taking into account the nature of the vehicle and the target market. For example, a sporting vehicle could be provided with greater lateral support, and a town or city car with less lateral support but more padding.

FIG. 8 illustrates a third embodiment in which the upstanding arms 246 are embedded within the composite laminate of the seat back 214 at the moulding stage. It is then convenient to place the boss 242 on the inner face of the seat back 214 as illustrated, but they could equally well be placed against an outer face. Thus, in this example the spindle 244 passes through, in sequence from the outside in, part of the rear side face of the seat back 214, the upstanding arm 246, the remainder of the rear side face of the seat back 214 and the boss 242, before engaging in the open aperture 252 of the reinforcement structure 224. No fixings are (strictly) needed in this embodiment as the upstanding arm 246 is secured in place, but such fixings could of course be provided in addition if desired. Soft and/or padded covers can of course be provided for the seat back 14 and the seat base 16, to allow greater comfort for those seated on them.

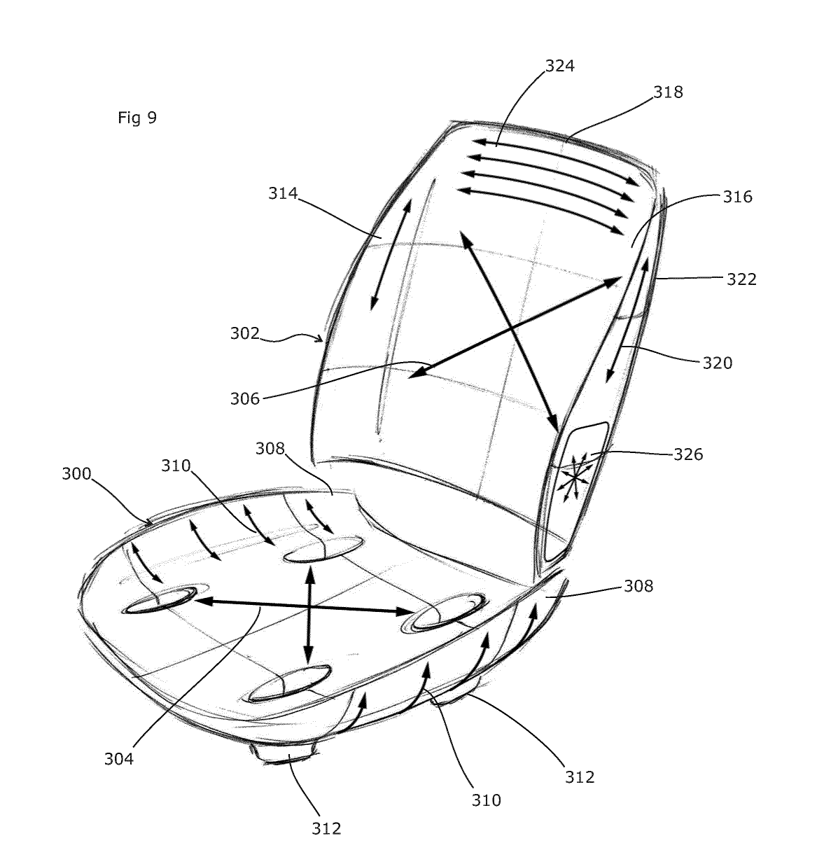

FIG. 9 illustrates the preferred fibre orientations for a fibre-reinforced composite material for use in the seat. These orientations differ in different locations on the seat base 300 and the seat back 302 in order to optimise the mechanical properties of the relevant part of the seat in the light of the expected mechanical loads. Thus, the various areas of the seat are as follows:
By default, where there is no specific fibre orientation for the seat region in question, the fibres are oriented in the seat base in a cross pattern 304, i.e. in each of the two directions that are at 45° to the longitudinal and lateral directions. Likewise, in the seat back the default fibre orientation is a cross pattern 306, in each of the two directions that are at 45° to the vertical and lateral directions. This pattern optimises the torsional stiffness of the seat, thus assisting the seat in retaining its shape despite supporting loads such as a human occupant. This pattern mainly covers the central part of the seat base 300 and of the seat back 302.
The upstanding lateral sides 308 of the seat base 300 have a locally unidirectional fibre orientation, with the fibres oriented in a lateral/upward direction 310. This provides the sides of the seat with good stiffness against outward bending forces, thus assisting in retaining a human occupant against sideways acceleration.
The seat mounts 312 for the seat base 300, i.e. the regions where the seat base 300 is attached to the vehicle, are formed with a quasi-isotropic fibre layup. This is a laminated arrangement in which multiple uni- or bi-directional layers are stacked in the laminate so as to exhibit an isotropic inplane response, i.e. a response that is independent of direction (although they may exhibit a non-isotropic out-of-plane response). This gives a strong and rigid material for use in the seat mounts 312.
Within the seat back 302, at least one area of uni-directional reinforcement arranged in an upward or vertical direction is provided in order to give the seat back good stiffness against bending under fore-aft loads. FIG. 9 illustrates our preferred location for this reinforcement, along the two outer lateral edges 314, 316. These two areas can if desired widen towards the top of the seat back 302, so as to meet in the middle 318 at the top edge of the seat back 302 in an arch formation in which the otherwise vertically-oriented fibres are deflected to an inward and upward direction.
A similar vertical unidirectional pattern 320 is provided on the side faces 322 of the seat back 302, for the same purpose.
Across the top edge of the seat back 302, a local unidirection pattern 324 of laterally-aligned fibres is provided. These extend from one side of the seat back 302 to the other side, across the top edge of the seat. In this area, they overly the top part of any arch formation of vertically/inwardly aligned unidirectional fibres. This provides good transverse stiffness to the seat back 302
Finally, a local quasi-isotropic woven pattern of reinforcement 326 is provided in the lower part of the seat back side faces 322 around the vertically-distributed join to the upstanding arms 46 forming the hinge elements. This allows good transfer of forces from the upstanding arms 46 into the seat back 302.

At the interface regions between different fibre orientations, there is an overlap area in which one fibre pattern blends into or is combined with the adjacent pattern, to prevent a weak unreinforced area from arising.

It will of course be understood that many variations may be made to the above-described embodiment without departing from the scope of the present invention.

1. A vehicle seat comprising a base unit and an upright seat back, the base unit being at least partly metallic, and comprising fixing points for attachment to the vehicle and at least two laterally-spaced upstanding arms, the seat back being of a moulded composite material and being attached to each upstanding arm via a vertically-distributed connection.

2. A vehicle seat according to claim 1, wherein the base unit comprises an adjustable mechanism for varying the angle between the upstanding arms and a remaining part of the base unit.

3. A vehicle seat according to claim 2 in which the adjustable mechanism comprises a spindle around which the remaining part rotates, and which extends inwardly into engagement with the seat back.

4. A vehicle seat according to claim 3 in which the spindle engages with a recess in the seat back.

5. A vehicle seat according to claim 4 in which the recess in the seat back is a blind recess.

6. A vehicle seat according to claim 4 or claim 5 in which the recess is a space located behind an upright transverse support section of the seat back.

7. A vehicle seat according to any one of the preceding claims in which the connections between the upstanding arms and the seat back are vertically distributed by comprising a plurality of mechanical attachments therebetween, spaced apart in the vertical direction.

8. A vehicle seat according to any one of claims 1 to 6 in which the connections between the upstanding arms and the seat back are vertically distributed by comprising an adhesive bond having an elongate extent in the vertical direction.

9. A vehicle seat according to any one of the preceding claims in which the connections between the upstanding arms and the seat back are vertically distributed by embedding the upstanding arms within the material of the seat back.

10. A vehicle seat according to any one of the preceding claims in which the base unit also comprises moulded composite materials.

11. A vehicle seat according to claim 7 in which the moulded composite materials of the seat base includes at least one region of uni-directional fibre orientation.

12. A vehicle seat according to any one of the preceding claims further comprising a seat base, attached to the base unit.

13. A vehicle seat according to claim 9 in which the seat base is of a moulded composite material.

14. A vehicle seat according to claim 10 in which the moulded composite material of the seat base includes at least one region of uni-directional fibre orientation.

15. A vehicle seat according to claim 9 or claim 10 in which the seat base is fixedly attached to the base unit.

16. A vehicle seat according to any one of the preceding claims in which the base unit includes slidable adjusters to allow the fore/aft position of the upstanding arms relative to the fixing points to be adjusted.

17. A vehicle seat according to any one of the preceding claims in which the upstanding arms are disposed adjacent to either lateral side of the seat back.

18. A vehicle seat according to any one of the preceding claims in which the seat back comprises reinforced sections define by multiple layers of moulded composite materials.

19. A vehicle seat according to claim 15 in which the multiple layers of moulded composite materials include at least one region of optimised fibre orientations.

20. A vehicle seat according to any one of the preceding claims in which the seat back comprises at least one region of uni-directional fibre orientation.

21. A vehicle seat according to claim 15 in which the moulded reinforced sections define at least one hollow space.

22. A vehicle seat according to claim 18 in which the at least one hollow space includes at least one upright tube having an opening at the upper edge of the seat, the seat further comprising a headrest having at least one downwardly-extending prong, the prong and the tube being slidably engageable thereby to retain the headrest above the seat in a vertically adjustable manner.

23. A vehicle seat according to any one of the preceding claims in which the composite material is a fibre-reinforced composite.

24. A vehicle seat according to claim 23 in which the fibre-reinforcement includes an area of unidirectional fibre reinforcement aligned in an upwards direction in the seat back.

25. A vehicle seat according to claim 24 in which the upwards-aligned unidirectional reinforcement is located on the two outer vertical edge regions of the seat back.

26. A vehicle seat according to claim 25 in which the two outer vertical edge regions increase in width towards a top edge of the seat back.

27. A vehicle seat according to claim 26 in which the two outer vertical edge regions meet at a central point of the top edge of the seat back.

28. A vehicle seat according to any one of claims 23 to 27 in which the fibre-reinforcement includes an area of unidirectional fibre reinforcement aligned in a lateral direction along a top edge of the seat back.

29. A vehicle seat according to any one of claims 23 to 28 in which the fibre-reinforcement of the seat back includes an area of quasi-isotropic laminated fibres covering at least the vertically-distributed connection with the upstanding arms.

30. A vehicle seat according to any one of claims 23 to 29 in which the fibre-reinforcement of the seat back includes an area of bi-directional reinforcement, aligned in each of the two directions that are at substantially 45° to the upright and lateral directions.

31. A vehicle seat according to any one of the preceding claims in which the base unit includes a seat base of a fibre-reinforced composite material.

32. A vehicle seat according to claim 30 in which the fibre-reinforcement includes an area of unidirectional fibre reinforcement in an outwards lateral direction in the sides of the seat base.

33. A vehicle seat according to claim 30 or claim 31 in which the fibre-reinforcement of the seat base includes an area of quasi-isotropic laminated fibres around a seat mounting area of the seat base.

34. A vehicle seat according to any one of claims 30 to 33 in which the fibre-reinforcement of the seat base includes an area of bi-directional reinforcement, aligned in each of the two directions that are at substantially 45° to the longitudinal and lateral directions.

35. A vehicle seat substantially as herein described with reference to and/or as illustrated in the accompanying figures.

36. A vehicle comprising at least one seat according to any one of the preceding claims.
